(19) United States
(12) Patent Application Publication
(10) Pub. No.: US 2013/0041548 A1
(43) Pub. Date: Feb. 14, 2013

(54) DRIVER ASSISTANCE SYSTEM AND METHOD FOR DRIVER ASSISTANCE

(71) Applicants: Wolfgang Krautter, Leonberg (DE); Michael Dambier, Bretten (DE)

(72) Inventors: Wolfgang Krautter, Leonberg (DE); Michael Dambier, Bretten (DE)

(21) Appl. No.: 13/576,680

(22) PCT Filed: Dec. 20, 2010
(86) PCT No.: PCT/EP2010/070177

§ 371 Date: Oct. 18, 2012

(30) Foreign Application Priority Data
Feb. 4, 2010 (DE) 10 2010 001 579.2

(51) Int. Cl. G06F 17/00; G05D 1/00; G08G 1/00

(52) U.S. Cl. 701/25; 701/118

(57) ABSTRACT

A driver assistance system for a vehicle having a device for detecting the surroundings and a device for detecting an instantaneous driving situation is described, the driver assistance system having a user interface, a device for detecting an upcoming driving route, and a device for assessing and evaluating a complexity of a driving task on the detected upcoming driving route.

### CROSS REFERENCE TO RELATED APPLICATIONS

The present application is the national stage entry of International Patent Application No. PCT/EP2010/070177, filed on Dec. 20, 2010, and claims priority to Application No. DE 10 2010 001 579.2, filed in the Federal Republic of Germany on Feb. 4, 2010.

### FIELD OF INVENTION

The present invention relates to a driver assistance system and a method for driver assistance for a vehicle, in particular a motor vehicle.

### BACKGROUND INFORMATION

While driving, a driver of a vehicle often performs so-called tertiary tasks which are not directly part of his driving task. Examples of such tertiary tasks include operating a radio and a navigation system, talking on the phone, eating, or drinking. The cognitive resources which a human being has available for simultaneously processing tasks or performing activities are limited. This means that the handling of a tertiary task by a driver more or less distracts the driver's attention away from the actual driving task. The driver's inattention is a significant cause of traffic accidents.

US Patent Publication No. 2006/0058963, International Patent Publication No. WO 2008/062403, and US Patent Publication No. 2005/0038573 propose driver assistance systems for a motor vehicle having a device for detecting the surroundings and a device for detecting an instantaneous driving situation; these devices evaluate a traffic situation and decide whether the traffic situation requires the undivided attention of the driver. If so, a possible distraction of the driver's attention away from the traffic events is reduced by switching off the information or entertainment systems.

### SUMMARY OF THE INVENTION

A driver assistance system and a method for driver assistance according to the present invention offer the advantage over the related art that according to the present invention, the driver assistance system indicates to the driver when the point in time is favorable to perform a tertiary task or tertiary activity. This is advisable when the driving surroundings or the traffic situation require(s) relatively little attention on the driver's part.

Another advantage is that the driving surroundings have been ascertained with the aid of already available or at least potentially available systems, in particular route information from a digital map and information on the surroundings with the aid of video cameras or a radar sensor.

The driver is able to communicate to the driver assistance system by pushing a button that he/she would like to perform a tertiary task. The driver assistance system then evaluates the instantaneous traffic volume. The raw information for this purpose may be supplied by video cameras or a radar sensor; in particular, the number of other vehicles in the immediate surroundings of the vehicle and their respective speeds may be detected. A computing unit or a microprocessor of the driver assistance system uses these data to calculate the complexity of the instantaneous driving situation with the aid of an algorithm.

Furthermore, the driver assistance system evaluates the structural complexity of the upcoming route, in particular of intersections, traffic lights, and highway on-ramps and curves. This information preferably originates from a stored digital map of a navigation system of the vehicle. When the driver lets a navigation system of the vehicle determine his/her route, the driver assistance system may also recognize approaching turning situations, lane changes, etc. These pieces of information or data are advantageously used to anticipatorily look for route sections where there is little complexity with regard to the driving task, thus requiring little attention from the driver.

Based on these data, the driver assistance system calculates an upcoming route section on which an ancillary task or a tertiary task is to be performed in a favorable manner. The driver assistance system communicates to the driver how long it will probably take until this route section is reached and/or how far away the start of this route section is, and indicates visually or acoustically when the time has come to attend to an ancillary task or tertiary task.

Exemplary embodiments of the present invention are described with reference to the accompanying drawings.

### BRIEF DESCRIPTION OF THE DRAWINGS

FIG. 1 shows a schematic representation of a driver assistance system according to one exemplary embodiment of the present invention.

FIG. 2 shows a flow chart of the method for driver assistance according to one exemplary embodiment of the present invention.

### DETAILED DESCRIPTION

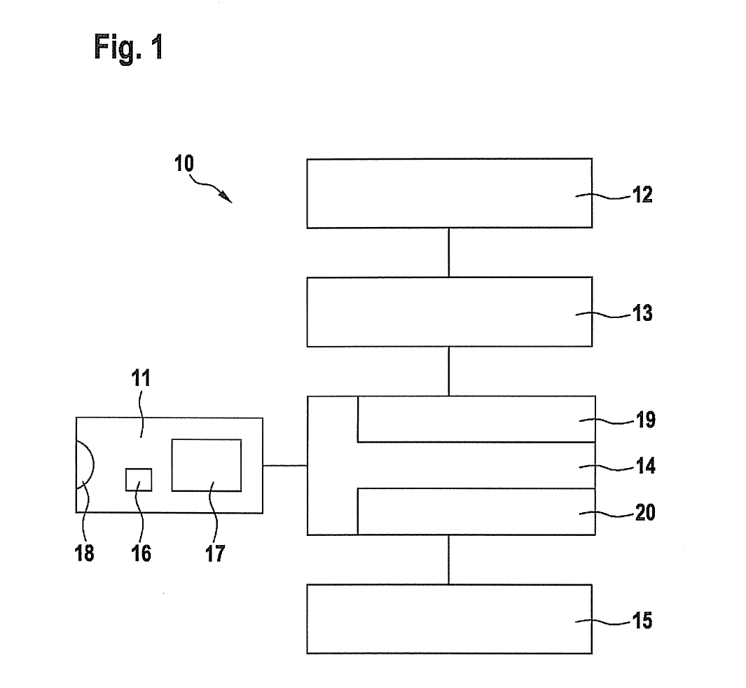

FIG. 1 shows a driver assistance system 10 for automatic driving according to one exemplary embodiment of the present invention.

Driver assistance system 10 may be implemented in a control unit. Driver assistance system 10 has an HMI (Human Machine Interface) or a user interface 11, a device 12 for detecting the surroundings, a device 13 for detecting an instantaneous driving situation, a device 15 for detecting an upcoming route, and a device 14 for assessing and evaluating a complexity of a driving task on the detected route.

User interface 11 has an operating element 16 for requesting an assessment regarding where and/or when a route section of little complexity of a driving task will be traveled on, and as output devices, has a monitor 17 and a loudspeaker 18.

Device 12 for detecting the surroundings uses sensors for detecting the surroundings which detect the road currently being traveled on and objects in the surroundings of the vehicle. Moving objects, for example, are detected by a radar sensor or cameras of the vehicle.

Device 13 for detecting an instantaneous driving situation ascertains the instantaneous driving situation, including the traffic density, from these data and advantageously from the data of the driver's own vehicle, such as speed, acceleration, steering angle.

Device 14 for assessing and evaluating a complexity of a driving task, in turn, has a device 19 for assessing a future driving situation and a device 20 for ascertaining a complexity of the surroundings of the upcoming route.

Device 14 for assessing and evaluating a complexity of a driving task uses device 20 for ascertaining a complexity of the surroundings of the upcoming route in order to calculate, section by section, the complexity of the surroundings of the upcoming route for the route sections, based on the map data of the upcoming driving route which were transmitted by device 15 for detecting an upcoming driving route. In one exemplary embodiment, the route information data are made available by a navigation system which has a GPS receiver at its disposal.

As a function of the instantaneous driving situation, in particular the traffic density, and the complexity of the surroundings of the upcoming route, device 14 assesses the complexity of the driving task on the detected route and calculates it. For this purpose, device 14 for assessing and evaluating a driving task ascertains the route sections of little structural complexity on which the complexity of the driving task is anticipated to be little based on the route surroundings. For each of these route sections, the future or the local driving situation is assessed based on the instantaneous driving situation as well as based on the structural surroundings and the possible traffic limitations known from the navigation data. The anticipated complexity of the driving task is assessed for each route section with the aid of the assessed driving situation and the structural complexity. For this purpose, an anticipated duration of an automatic driving of the vehicle is also ascertained, taking into consideration the traffic density. A route section of little complexity of the driving task and having a predefinable minimum duration to be traveled on is ascertained with the aid of comparison.

Device 14 for assessing and evaluating a complexity of a driving task communicates to the driver via user interface 11 the information where or at which location and/or when and of what anticipated duration there is a route section of little complexity of the driving task. The information regarding at what location there is a route section of little complexity may indicate the distance from the instantaneous position of the vehicle until the start of the route section of little complexity of the driving task. The information regarding when there is a route section of little complexity may indicate the time interval after which the vehicle is anticipated to reach the start of this route section. As soon as the route section of little complexity is reached, user interface 11 communicates to the driver that predominantly automatic driving of the vehicle is now possible.

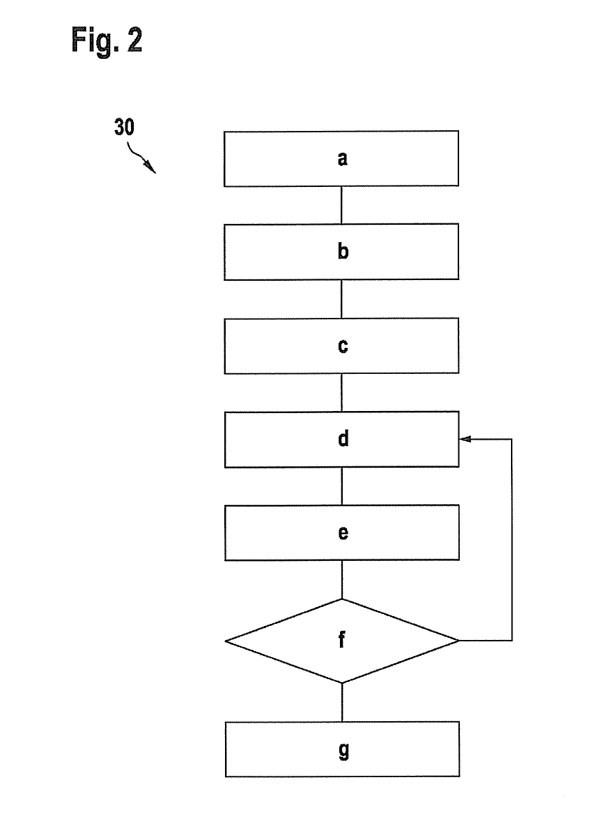

In FIG. 2, a flow chart 30 shows the method for driver assistance according to one exemplary embodiment of the present invention. The method is elucidated with reference to driver assistance system 10 from FIG. 1.

The method starts with method step (a), namely with the driver requesting an assessment regarding where and/or when a route section of little complexity of a driving task will be traveled on, with the aid of operating element 16 of user interface 11.

Subsequently, driver assistance system 10 carries out method step (b), namely detecting the instantaneous driving situation, in its device 13 for detecting an instantaneous driving situation. This takes place with the aid of device 12 for detecting the surroundings and the corresponding sensors, which detect the road currently being traveled on and the objects in the surroundings of the vehicle, as well as, in this example, with the aid of the data of the driver's own vehicle, e.g., speed, acceleration, or steering angle.

Moreover, driver assistance system 10 carries out method step (c), namely detecting an upcoming route, in its device 15 for detecting an upcoming route. For this purpose, the structural data of the upcoming route are compiled from navigation data. This takes place either for a driving route calculated with the aid of a navigation system, or, in the case of driving without making use of a navigation system, based on a likely driving route ascertained according to plausibility criteria. Method steps b) and c) may be carried out in any desired sequence or in parallel.

The driving situation, including the traffic density and data regarding the upcoming route, are input into device 14 for assessing and evaluating a complexity of a driving task, where a method step (d) is carried out, namely assessing and evaluating a driving task on the detected route. This takes place with the aid of device 19 for assessing a future driving situation on the detected route based on the instantaneous driving situation, by using the ascertained traffic density.

In device 20 for ascertaining a complexity of the surroundings of the upcoming route, the complexity for route segments determined from the route data is determined based on the map data of the upcoming route. The road class, curve segments, or straight route segments are used, for example, to categorize the route sections. When assessing and evaluating the future driving situation, device 14 for assessing and evaluating a complexity of a driving task ascertains a route section of little complexity of the driving task which includes one or multiple route segments, taking into consideration the traffic density. For this purpose, an anticipated duration of travel on the route section of little complexity of the driving task is ascertained. It is possible to predefine or set a minimum duration so that route sections are searched for whose duration of a predominantly automatic driving of the vehicle is greater than the predefined minimum duration. The duration or the driving duration for a route section is calculated using the likely driving speed of the vehicle for this route section known from the navigation data.

Furthermore, device 14 for assessing and evaluating a complexity of a driving task ascertains the distance and the anticipated driving time until the start of the route section of little complexity of the driving task. This information is output via user interface 11 in a method step (e), it being communicated to the driver where and/or when there is a driving situation of little complexity of the driving task.

In this exemplary embodiment, it is provided according to one possible exemplary embodiment of the present method according to the present invention that driver assistance system 10, which tracks and monitors the drive, checks in a method step (f) whether a route section of little complexity of the driving task has been reached. If this is not the case, the process branches back to method step (d), and the position of the vehicle is adjusted to the navigation data, the distance and the anticipated driving time until the start of the route section being continuously updated. Upon reaching the route section of little complexity of the driving task, it is communicated to the driver in a method step (g) that a driving situation of little complexity of the driving task is now present.

There are several possibilities for using the route section of little complexity of the driving task. In a first exemplary embodiment, only a piece of information is communicated to the driver that the time for a tertiary task is favorable because the surrounding traffic requires relatively little attention from the driver to drive the vehicle; no further assistance is provided by vehicle assistance system 10.

In a second exemplary embodiment, semi-autonomous driving of the vehicle or assistance of the driver by driver assistance system 10 may take place. This may, for example, involve an integrated lateral guidance, i.e., assistance in lanekeeping, or an adaptive cruise control (ACC), i.e., control of the speed and the distance to other vehicles.

In a third exemplary embodiment, predominantly automatic driving of the vehicle may be activated either automatically or upon the driver's request.

The vehicle may be any vehicle, in particular a motor vehicle for road traffic. The motor vehicle is a passenger car or a truck. Furthermore, the vehicle may, for example, also be a watercraft for shipping traffic, in particular for inland waterway traffic or for deep sea transportation.

1-14. (canceled)

15. A driver assistance system for a vehicle, comprising:
a device configured for detecting the surroundings;
a device configured for detecting an instantaneous driving situation;
a user interface;
a device configured for detecting an upcoming driving route; and
a device configured for assessing and evaluating a complexity of a driving task on the detected upcoming driving route.

16. The driver assistance system according to claim 15, wherein the device configured for detecting the instantaneous driving situation ascertains a traffic density.

17. The driver assistance system according to claim 15, further comprising:
a device configured for ascertaining a complexity of route surroundings of the upcoming driving route.

18. The driver assistance system according to claim 15, wherein the device configured for assessing and evaluating the complexity of the driving task on the detected upcoming driving route is configured such that an assessment is carried out regarding when and how long a route section of little complexity of the driving task is traveled on.

19. The driver assistance system according to claim 15, wherein the user interface is configured to output a piece of information related to the vehicle traveling on a route section of little complexity of the driving task.

20. A method for driver assistance for a vehicle, comprising:
requesting an assessment regarding at least one of where and when a route section of little complexity of a driving task is traveled on;
detecting an instantaneous driving situation;
detecting an upcoming driving route;
assessing and evaluating a driving task on the detected upcoming driving route;
ascertaining and outputting at least one of where and when the route section of little complexity of the driving task is traveled on.

21. The method according to claim 20, wherein the detecting the instantaneous driving situation includes ascertaining a traffic density.

22. The method according to claim 20, wherein the detecting the upcoming driving route is carried out on a basis of navigation data.

23. The method according to claim 20, wherein the assessing and evaluating includes evaluating a complexity of route surroundings.

24. The method according to claim 20, wherein the assessing and evaluating includes assessing a future driving situation based on traffic density and route surroundings.

25. The method according to claim 23, wherein the ascertaining and outputting includes ascertaining an upcoming route section of little complexity of the route surroundings.

26. The method according to claim 20, wherein the ascertaining and outputting includes ascertaining and outputting a duration of travel on the route section of little complexity of the driving task.

27. The method according to claim 20, further comprising:
after the ascertaining and outputting, communicating a message to a driver that the route section of little complexity of the driving task is present.

28. The method according to claim 20, further comprising:
one of automatically and semi-automatically driving the vehicle on the route section of little complexity of the driving task.
